(19) United States
(12) Patent Application Publication
(10) Pub. No.: US 2015/0138098 A1
(43) Pub. Date: May 21, 2015

(54) Patterned tactile touch interface overlay

(71) Applicant: Timothy Jordan Potter, Mountain View, CA (US)

(72) Inventor: Timothy Jordan Potter, Mountain View, CA (US)

(21) Appl. No.: 13/998,596

(22) Filed: Nov. 15, 2013

(51) Int. Cl. G06F 3/041

(52) U.S. Cl. CPC G06F 3/0418
USPC 345/173

(57) ABSTRACT

An improved touch screen overlay is disclosed. The overlay has novel structures, which provide for the prevention of unintended touch screen button actuation, allows access to on-screen buttons, provides finger positioning cues, and provides button identification cues.

### BACKGROUND

### Prior Art

The following is a tabulation of some prior art that presently appears relevant:

### U.S. Patents

| | Kind | | |
|---|---|---|---|
| Pat. No. | Code | Issue Date | Patentee |
| U.S. Pat. No. 5,594,471 | A | 1997-1-14 | Casco Development, Inc. |
| U.S. Pat. No. 6,492,978 | B1 | 2002-12-10 | NCR Corporation |
| U.S. Pat. No. 8,206,047 | B1 | 2012-6-26 | TouchFire, Inc. |
| U.S. Pat. No. 6,667,738 | B2 | 2003-12-23 | Vtech Communications, |
| | | | Inc. |
| U.S. Pat. No. 5,572,573 | A | 1996-11-05 | U S West Advanced |
| | | | Technologies, Inc. |
| U.S. Pat. No. 5,917,906 | A | 1999-06-29 | Ericsson, Inc. |
| U.S. Pat. No. 5,887,995 | A | 1999-03-30 | Compaq Computer |
| | | | Corporation |

### U.S. Patent Application Publications

| | | | |
|---|---|---|---|
| US20060050061 | A1 | 2006-3-9 | Mattel, Inc. |
| | A1 | 2004-10-28 | Microsoft Corporation |
| US20020021289 | B2 | 2002-2-21 | International Business |
| | | | Machines Corporation |

Users of electronic devices with touch screen input methods often complain of the difficulty of accurately inputting information. The touch screen lacks sufficient tactile properties as the touch screen is flat, the user has no way to differentiate between inputs by touch. This lack of tactile buttons often causes distress to users, especially when they accidentally actuate an unintended on-screen button. Physical buttons or keys provide the user with haptic feedback, allowing them to more easily verify the intended input. The lack of discrete input surfaces on a touch screen results in difficulties with accurately inputting information.

Further, many touch screen buttons are more narrow than the width of the average finger. This compounds the problem of accurately contacting the on-screen button to actuate the on-screen button. To complicate this, many touch screen buttons are placed very close together. This close proximity greatly increases the probability that the finger of the user will unintentionally contact and subsequently actuate an adjacent button before contacting the intended button, even if the user's finger initially contacts the appropriate on-screen button.

Many touch screen interfaces actuate the on-screen button that the user's finger is contacting immediately prior to release, not the on-screen button that the user's finger initially contacts. This creates a frustrating experience for the user, especially for the users who are unaware of this user interface nuance. With the lack of tactile feedback the user is more likely to believe that they had in fact actuated the intended on-screen button when in fact an adjacent button was contacted and actuated unintentionally.

U.S. patent application 20,020,021,289 to Combs et al. (2002) includes an overlay to define a pattern for the touch screen. The device consists of an overlay on a touch pad. The purpose of the overlay in the prior art is to act as a map of the correlating touch pad functions. The overlay serves to define the functions of the touch pad. The overlay does not act as a guard to prevent or inhibit accidental activation of touch pad functions. The overlay has no tactile implications, as its purpose is simply to indicate touch pad functions visually.

U.S. Pat. No. 8,206,047 to Isaac et al. (2012) includes keyboard overlays that comprise rubber sheets that are formed into keyboard shapes. The purpose of these keyboard overlays is to act as a tactile reference point for the typist so that they can type without looking at a screen. By placing a keyboard analog over the keys of a virtual keyboard the typist types more slowly than they otherwise would by having to physically compress the keyboard overlay before actuating the touch screen.

U.S. patent application 20,040,212,598 to Kraus et al. (2004) is a keyboard overlay. This overlay relies on physical keys that must be depressed so that the overlay subsequently delivers enough pressure to the touch screen to actuate an on-screen key. The physical keys slow down the actuation of on-screen keys resulting in slower data entry.

U.S. Pat. No. 6,667,738 to Murphy (2003) references raised domes as part of a touch screen overlay. The dome as a point of contact is insufficient. The dome makes it easy for a finger or stylus to slip and lose sufficient contact with the overlay to activate displayed buttons. A dome is a gradual change in thickness, resulting in tactile information for the user that is less clear and thus less usable. The dome shape also does not provide a fully raised surface above the entire displayed button, further adding to the tactile ambiguity for the user.

U.S. Pat. No. 5,917,906 to Thornton (1999) includes domes that snap into an overlay. Again, the dome as a point of contact is insufficient. The dome makes it easy for a finger or stylus to slip and lose sufficient contact with the overlay to activate displayed buttons. A dome is a gradual change in thickness, resulting in tactile information for the user that is less clear and thus less usable. The dome shape also does not provide a fully raised surface above the entire displayed button, further adding to the tactile ambiguity for the user.

U.S. Pat. No. 5,887,995 to Holehan (1999) includes a curved surface that deforms in response to a sufficient amount of force applied to a response element by a computer operator. The overlay provides positive tactile feedback to indicate when an overlay button was actuated. The need to deform a surface slows data input.

U.S. Pat. No. 5,594,471 to Carll et al. (1997) identifies user input areas of a touch zone with printed indicia on an overlay.

U.S. Pat. No. 6,492,978 to Selig et al. (2002) includes physical keys positioned over a touch screen. The need to physically move the key slows data input.

U.S. Pat. No. 5,572,573 to Marx et al. (1996) references a raised overlay having a plurality of apertures of predetermined size, shape, and location corresponding to the predetermined plurality of touch screen function labels. Buttons on touch screens are increasingly small. I found that this smaller size compounds the problem of accurately actuating on-screen soft buttons. Subsequently, I found that these on-screen buttons are so small that an overlay having a plurality of apertures corresponding to a plurality of small on-screen buttons will increase the difficulty of accurately actuating on-screen buttons.

### ADVANTAGES

Thus several advantages of one or more aspects are to provide a more user-friendly experience. Other advantages of one or more aspects are to provide a more accurate actuation of on-screen buttons, and easier access to and actuation of small on-screen buttons. Additionally, an aperture allows for quick access to on-screen buttons. Apertures in an overlay that approximate on-screen buttons are able to provide an optimal user experience despite the chosen layout of on-screen buttons. These and other advantages of one or more aspects will become apparent from a consideration of the ensuing description and accompanying drawings.

### DRAWINGS—FIGURES

FIG. 1 is a perspective view of a first embodiment of my overlay.

DRAWINGS - Reference Numerals

| | | | |
|---|---|---|---|
| 10 | aperture | 12 | ridge |
| 14 | edge of aperture | 16 | depression |
| 18 | frame | 20 | touch screen |

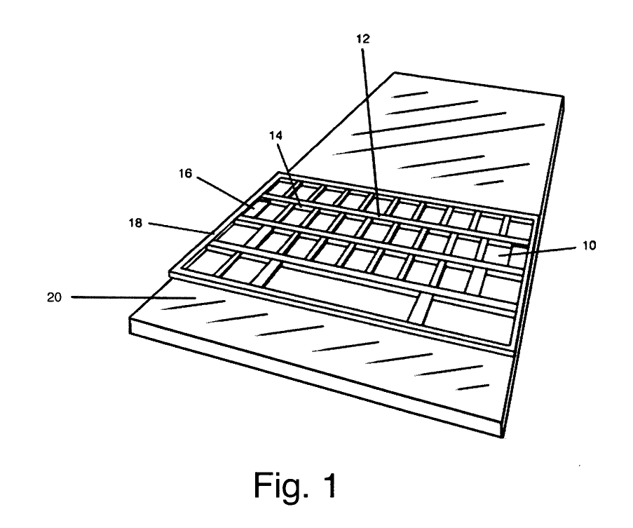

### DETAILED DESCRIPTION—FIG. 1

### First Embodiment

FIG. 1 shows a perspective view of one embodiment of my overlay. This embodiment consists of a frame 18 that outlines the edge of the touch screen 20 display. Ridges 12 connect the frame 18 across the touch screen 20, projected between on-screen buttons. Additional ridges 12 connect the main ridges 12, projected between on-screen buttons. At certain locations between the frame 18 and the ridges 12 there are depressions 16 in the overlay. The frame 18, ridges 12, connecting ridges 12, and/or depressions 16 create the edges 14 of each aperture 10.

### Operation —FIG. 1

In one embodiment of the invention an overlay would lie adjacent to a touch screen 20. The user would be able to interact with any buttons that are displayed on the touch screen 20 through any aperture 10 of the overlay. The user would also be able to interact with the touch screen 20 by using, for example, commands that involve dragging a finger or an input implement across the touch screen 20. In other words, the user is able to interact with the touch screen interface as they normally would without hindering the effect of their gesture

A user would open an application that displays buttons that approximate the edges of apertures 14 in the overlay. The user would then input data to the device by actuating on-screen buttons. The user would find that their inputs are more accurate than without the overlay. If a user's finger is not perfectly centered on a button, the edge of the aperture 14 would provide sufficient support to prevent contact with and the subsequent actuation of an adjacent button while allowing actuation of the intended key through the aperture 10.

The presence of the edge of the aperture 14 would displace the user's finger into the aperture 10 of the intended button and subsequently actuate the intended button, or the edge of the aperture 14 would act to support the user's finger above the undesired button thus preventing accidental actuation of an unintended on-screen button.

If the overlay were not present near the edge of the desired on-screen button, a user's finger would contact a nearby button after first contacting the intended on-screen button. The subsequent break of contact with the user's finger with the unintended on-screen button would actuate the unintended on-screen button despite first contacting the intended on-screen button.

### CONCLUSION, RAMIFICATIONS, AND SCOPE

Thus the reader will see that at least one embodiment of the overlay provides a more reliable, more accurate, more user friendly, yet economical device that can be used by persons of almost any age.

While my above description contains many specificities, these should not be construed as limitations on the scope, but rather as an exemplification of one or several embodiments thereof. Many other variations are possible.

For example the overlay would be implemented for a game application that has a unique button pattern on the touch screen.

An embodiment would be made of a various materials including rubber, silicone, metals, ceramics, cellulose, and various other materials.

An embodiment would be made of a transparent material or alternatively made of an opaque material of any color.

An embodiment would be of various dimensions.

An embodiment would be used with a large variety of devices that use a touch interface.

An embodiment would employ various attachment mechanisms. An embodiment would attach directly to the device, or an embodiment would attach to a case or other type of indirect attachment method.

An embodiment would be used with a stylus or other input implement.

An embodiment would have the potential for a user to actuate any coordinate on the touch screen through the overlay. Another embodiment would lack the potential for a user to actuate any coordinate on the touch screen through the overlay.

Accordingly, the scope should be determined not by the embodiment illustrated, but by the appended claims and their legal equivalents.

I claim:

1. An article comprising a touch screen overlay that inhibits actuation of nearby buttons, comprising:
2. a touch screen having a plurality of predetermined on-screen buttons; and
3. said overlay comprising a sheet with a plurality of apertures of predetermined size, shape, and location whose edge approximates the edge of predetermined on-screen buttons.
